(19) United States
(12) Patent Application Publication
(10) Pub. No.: US 2022/0301746 A1
(43) Pub. Date: Sep. 22, 2022

(54) Cold Lead Termination Method

(71) Applicant: Schluter Systems L.P., Plattsburgh, NY (US)

(72) Inventor: Gilles Gagnon, Quebec (CA)

(21) Appl. No.: 17/206,042

(22) Filed: Mar. 18, 2021

(51) Int. Cl. H01B 17/58; H02G 15/18

(52) U.S. Cl. CPC H01B 17/58; H02G 15/18

(57) ABSTRACT

A heating cable assembly includes a joint housing that includes a body formed of an electrically insulating material. The body includes a floor, a pair of outer walls and a pair of inner walls positioned intermediate the pair of outer walls. The walls form an inner insulating channel and a pair of outer insulating channels. A pair of openings is defined above each of the insulating channels, the openings being devoid of material to allow at least a portion of one or more conductors to be installed into the insulating channels from above. One of two hot conductors and one of two cold conductors are connected at a first joint and another hot conductor and another cold conductor are connected at a second joint. The first and second joints are positioned in one of the insulation channels beneath one of the openings with an insulating wrap installed about the housing.

### BACKGROUND OF THE INVENTION

### Field of the Invention

The present invention relates generally to heating cable sets. More particularly, the present technology relates to cable sets that can be used in electrical floor heating systems installed beneath floor covering applications, such as ceramic tiles, stone, wood, etc.

### Related Art

Electrical heating cable sets can be installed beneath traditional flooring applications to warm the floor from beneath. In most such installations, the heating cable set includes a hot cable section, or a hot lead, that forms the hot section of the heating cable set that is installed beneath the floor. Heat is generated as current flows through conductors of the hot cable section. A cold cable section, or a cold lead, is generally connected between a thermostat and the heating cable section to form a heating cable set. The cold lead is generally run within a wall or similar structure. As such, it provides current to the hot lead but does not itself significantly increase in temperature during operation.

The heating cable section is generally buried beneath the floor covering materials, where it is desired to create heat, while the cold cable section is generally hidden behind materials or structure, where it is not desired to create heat (e.g., within wall cavities). The location at which the heating cable section and the cold cable section are joined together is therefore generally located within the flooring installation, as the heating cable section should not extend beyond the flooring installation. The splicing of the heating cable section and cold cable section at this location often results in a joint that is much bulkier than either the heating cable section or the cold cable section. Installers typically bury this joint beneath tiles and mortar very near an edge of the floor covering installation. Due to the size of the joint, it is sometimes required of the installer to gouge a hole within the subfloor material to ensure that the joint is low enough to not interfere with the floor covering installation. For applications where a membrane is installed under the heating cable sets for the purpose of uncoupling tile relative to and/or waterproofing the subfloor, the membrane will also need to be cut to lower the position of the joint. In these cases, a sealant needs to be applied around the joint and on the membrane to render it waterproof again at that location.

Thus, while in-floor heating cable sets have been, and continue to be, used with success, efforts continue to seek a jointing process that minimizes the impact the joint has on the flooring installation.

### SUMMARY OF THE INVENTION

In accordance with one aspect of the invention, a cable joint housing is provided, including a body integrally formed of an electrically insulating material. The body can include a floor and a pair of outer walls, extending upwardly from the floor. A pair of inner walls can extend upwardly from the floor and can be positioned intermediate the pair of outer walls. The inner walls can form an inner insulating channel and each of the pair of inner walls can form an outer insulating channel with an adjacent outer wall. A pair of openings can be defined above each of the insulating channels, the openings being devoid of material to allow at least a portion of one or more conductors to be installed into the insulating channels from above, through the openings.

In accordance with another aspect of the technology, a heating cable assembly is provided, including a cable joint housing having a body integrally formed of an electrically insulating material. The body can include a floor and a pair of outer walls, extending upwardly from the floor. A pair of inner walls extend upwardly from the floor and are positioned intermediate the pair of outer walls. The inner walls can form an inner insulating channel and each of the pair of inner walls can form an outer insulating channel with one of the adjacent outer walls. A pair of openings can be defined above each of the insulating channels. The openings can be devoid of material to allow at least a portion of one or more conductors to be installed into the insulating channels from above, through the openings. A hot cable can include at least two hot conductors and a cold cable can include at least two cold conductors. One of the hot conductors and one of the cold conductors are connected at a first joint and another of the hot conductors and another of the cold conductors are connected at a second joint. The first and second joints can be positioned in one of the insulation channels beneath one of the openings. An insulating wrap can be installed about the housing and can provide an insulative barrier above the first and second joints.

In accordance with another aspect of the technology, a method is provided of finishing a cable assembly. The method can include obtaining a cable joint housing having a body integrally formed of an electrically insulating material. The body can include a floor and a pair of outer walls, extending upwardly from the floor. A pair of inner walls can extend upwardly from the floor and can be positioned intermediate the pair of outer walls. The inner walls can form an inner insulating channel and each of the pair of inner walls can form with one of the adjacent outer walls an outer insulating channel. A pair of openings can be defined above each of the insulating channels, the openings being devoid of material to allow at least a portion of one or more conductors to be installed into the insulating channels from above, through the openings. The method can include positioning through one of the openings a first joint of a heating cable in one of the insulation channels such that the first joint sits beneath the one of the openings. A second joint of a heating cable can be positioned through another of the openings in another of the insulation channels such that the second joint sits beneath the another of the openings. An insulating wrap can be installed about the housing to thereby provide an insulative barrier above the first and second joints.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a top view of a wire joint housing in accordance with an aspect of the technology;

FIG. 2 is a side view of the housing of FIG. 1;

FIG. 2A is an enlarged sectional view of the housing of FIG. 1, taken through section A-A of FIG. 2;

FIG. 3 is a top view of the housing of FIG. 1, with conductors and joints of a pair of cables installed therein; and

FIG. 4 is a top view of the arrangement of FIG. 3, with an insulating wrap installed thereover.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### Definitions

As used herein, the singular forms “a” and “the” can include plural referents unless the context clearly dictates otherwise. Thus, for example, reference to “a conductor” can include one or more of such conductors, if the context so dictates.

As used herein, the term “substantially” refers to the complete or nearly complete extent or degree of an action, characteristic, property, state, structure, item, or result. As an arbitrary example, an object that is “substantially” enclosed is an article that is either completely enclosed or nearly completely enclosed. The exact allowable degree of deviation from absolute completeness may in some cases depend upon the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. As another arbitrary example, a composition that is “substantially free of” or “devoid of” an ingredient or element may still actually contain such item so long as there is no measurable effect as a result thereof.

As used herein, the term “continuous” is sometimes used to refer to a component or structure that is an integral, complete and unbroken piece. A component that is applied as a “continuous” unit can include a material having no discontinuities, breaks or other sections lacking material from which the component is formed. As one example, a ground braid is sometimes applied herein over other conductor segments: while a ground braid may include discontinuities in the material from which the braid is formed (e.g., openings or spaces between wires of the braid), when the ground braid is applied as a continuous unit, the same piece or unit of such material is applied without interruption, even if small holes or openings otherwise appear throughout the continuous piece of material.

The term “conductor” is used herein to refer to electrically conductive materials. In some cases, a conductor is comprised of a single, solid piece of metal (for example, a conductor that is commonly referred to as a solid wire conductor). In other cases, a conductor can include a single conductor formed of many smaller conductors twisted into a single unit (for example, a conductor commonly referred to as a stranded wire conductor). As those terms are used herein, either or both a “hot” or “cold” “cable section” can include a single insulated conductor (either solid or stranded), or can include two or more insulated conductors twisted into a cable section (or run parallel to one another as a cable section). For example, while reference may be made to “a” hot cable section, it is to be understood that such a section may include one, two or more insulated conductors (solid or stranded) configured as a single conductor for use as a hot conductor herein.

Reference can be made herein to hot and cold conductors. This reference is not made with regard to whether or not a conductor is carrying current. The floor warming cables disclosed herein include two primary components: a “hot” cable section having one or more “hot” conductors which is configured to generate appreciable heat when subjected to a current, and a “cold” cable section having one or more cold conductors which is configured to exhibit very little, if any, appreciable warming when subjected to a current. These conductors are joined at a splice: on one side of the splice, as current is applied to the overall cable, the cold conductor carries current to and from the hot conductor but does not, itself, generate much heat. On the other side of the splice, the hot conductor, in contrast, generates appreciable heat when subjected to the current. Thus, a “cold” conductor, as that term is used herein, may very well be “live:” that is, it may be carrying an electrical current even if it does not appreciably increase in temperature while carrying that current.

As used herein, the term “about” is used to provide flexibility to a numerical range endpoint by providing that a given value may be “a little above” or “a little below” the endpoint.

Relative directional terms can sometimes be used herein to describe and claim various components of the present invention. Such terms include, without limitation, “upward,” “downward,” “horizontal,” “vertical,” etc. These terms are generally not intended to be limiting, but are used to most clearly describe and claim the various features of the invention. Where such terms must carry some limitation, they are intended to be limited to usage commonly known and understood by those of ordinary skill in the art in the context of this disclosure. In some instances, dimensional information may be included in or referenced by the figures. This information is intended to be exemplary only, and not limiting, except where the context dictates otherwise. In some cases, the drawings are not to scale and such dimensional information may not be accurately translated throughout the figures.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Invention

The present technology relates generally to systems used beneath floor covering installations to warm the floor covering surface. While the present technology is not so limited, the discussion herein will focus primarily on the use of electric heating cable sets installed beneath ceramic tiles. The systems can be equally effective beneath wood floors, polymer floors, composite floors, etc. In such systems, membranes such as those commercially known as Schuter's DITRA-HEAT® can be secured to a subfloor, after which a heating cable set can be run in a generally repeating back-and-forth pattern and held within securing features of the membrane. Ceramic tiles can then be installed over the membrane and heating cable. As current is applied through the heating cable, the ceramic tiles are heated, creating a pleasantly warmed floor beneath a user's feet.

Such heating cable sets typically include two primary sections: a “cold” lead or cold cable section, and a “hot” lead or hot cable section. The hot lead is installed beneath the floor covering and the cold lead carries current to and from the hot lead. The hot cable section generally includes “hot” conductors which are configured to generate appreciable heat when subjected to a current. The cold cable section has “cold” conductors which are configured to exhibit very little, if any, appreciable warming when subjected to a current. These conductors are joined at a splice or joint: on one side of the splice, as current is applied to the overall cable, the cold conductor carries current to and from the hot conductor but does not, itself, generate much heat. On the other side of the joint, the hot conductor, in contrast, generates appreciable heat when subjected to the current.

The location at which the heating cable section and the cold cable section are joined together is generally located within the flooring installation, as the heating cable section should not extend beyond the flooring installation. The splicing of the heating cable section and cold cable section at this location often results in a joint that is much bulkier than either the heating cable section or the cold cable section. Installers typically bury this joint beneath tiles and mortar very near an edge of the floor covering installation. Due to the size of the joint, it is oftentimes required of the installer to gouge a hole within the subfloor material to ensure that the joint is low enough to not interfere with the floor covering installation. For applications where a membrane is installed under the heating cable sets for the purpose of uncoupling tile relative to and/or waterproofing the subfloor, the membrane will also need to be cut to lower the position of the joint. In these cases, a sealant needs to be applied around the joint and on the membrane to render it waterproof again at that location.

The present technology provides systems and methods of allowing installation of the splice joint in the flooring area of the installation without requiring significant alteration of the flooring installation components. In particular, the present technology provides a streamlined joint that is sufficiently low in height that it can be installed at the same level as the heating membrane without requiring that the subfloor beneath the membrane be partially removed to accommodate the joint. In some cases, the present technology may require that a portion of the membrane be removed to accommodate the joint, but none of the subfloor need be removed.

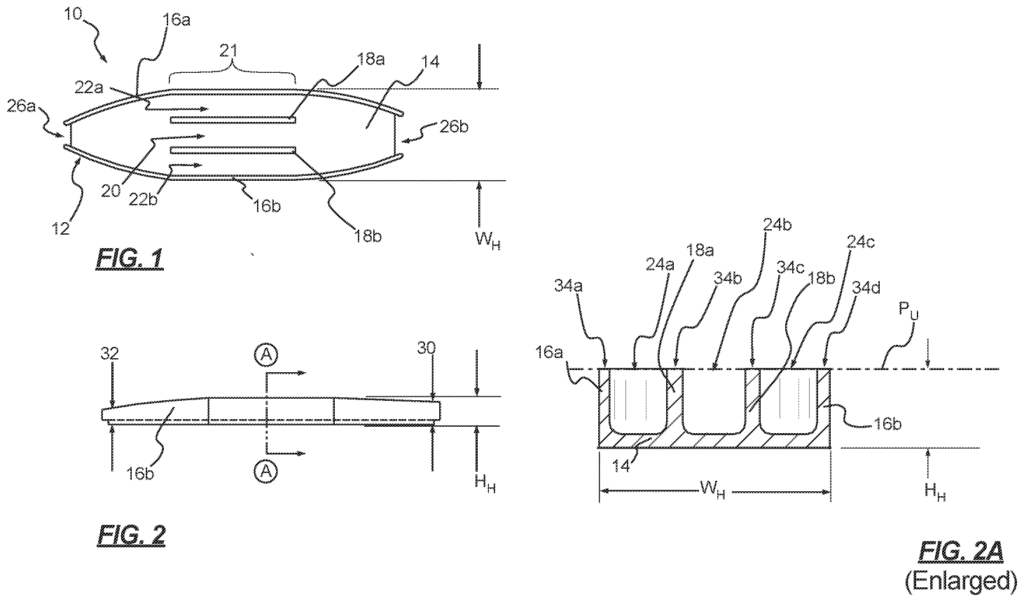

As shown generally in FIGS. 1 through 2A, in one aspect of the technology, a cable joint housing 10 can be provided that can include a body 12. The body can be integrally formed of an electrically insulating material, such as polypropylene, polyamide, polyester, polycarbonate and the like. The body can include a floor 14 and a pair of outer walls 16a, 16b extending upwardly from the floor. A pair of inner walls 18a, 18b can also extend upwardly from the floor and can be positioned intermediate the pair of outer walls. The inner walls can form an inner insulating channel 20 and each of the pair of inner walls can form, together with an adjacent outer wall, an outer insulating channel 22a, 22b.

Openings 24a, 24b, 24c (FIG. 2A) can be defined above each of the insulating channels. The openings can be devoid of material to allow at least a portion of one or more conductors (as discussed in further detail below) to be installed into the insulating channels from above, through the openings. The housing can allow a pair of cables, in most cases a hot and cold lead from a heating cable set, to be connected to one another in a manner that provides only a very minimal height increase relative to the height of the cables themselves. In this manner, the housing can be installed in a flooring installation without requiring significant alteration of the subfloor beneath the flooring installation.

While the physical characteristics of the housing 10 can vary, in one aspect of the technology, a maximum width of the housing (WH in FIG. 1) is at least three times a maximum height of the housing (HH in FIGS. 1 and 2A). In one non-limiting example, the width of the housing is about 0.62 inches and the height of the housing is on the order of about 0.18 inches. An overall length of the housing can be around 2.70 inches.

As can be appreciated from FIGS. 1 and 2A, the inner walls 18a, 18b can be spaced and distinct from the outer walls 16a, 16b. In this manner, distinct insulating channels 20, 22a, 22b can be formed that allow conductors be extend through the channels and be insulated from contact with adjacent conductors. The insulating channels are thus bordered on each side by a wall 16a, 16b, 18a, 18b, etc., formed from an electrically insulating material and are open at the ends. Thus, the channels generally extend along a length shown at reference 21 in FIG. 1 but allow the conductors to exit the body 12 at end openings 26a, 26b. In the example shown, end opening 26b is larger than 26a, to accommodate the difference in diameter of the conductors (discussed in further detail below). Similarly, while not required, a height 30 (FIG. 2) of the body at end opening 26b can be larger than a height 32 at end opening 26a.

As shown in FIG. 2A, the inner walls 18a, 18b and outer walls 16a, 16b each terminate in an upper surface or edge, 34a, 34b, 34c, 34d, etc. In one example, these upper surfaces of the inner and outer walls lie on substantially the same plane, Pu. In this manner, even though the diameters of the conductors housed in the body 12 may differ, the housing presents a consistent cross section through the insulating channel area.

The inner walls 18a, 18b and outer walls 16a, 16b can generally be freestanding under their own weight. That is, under normal operating conditions, the body 12 retains its shape, even under moderate loading. In one example, the body (and hence the walls) is formed from one or more of the materials referenced above and the wall thickness can be on the order of 0.8 mm to 1.5 mm. In this manner, the structure of the housing is relatively rigid, but flexible: thus, while the housing can be deformed slightly by application of sufficient force, it is at least sufficiently rigid to withstand forces typically applied to a tiled floor. In addition, the housing is generally capable of withstanding temperatures far in excess of those applied in a typical tile installation, as in some cases an insulating wrap or tubing (discussed below) is heated to as high as 125 degrees C. about/around the housing, which can result in the housing being exposed to considerable heat. The housing is configured to hold its shape and configuration in both of these instances.

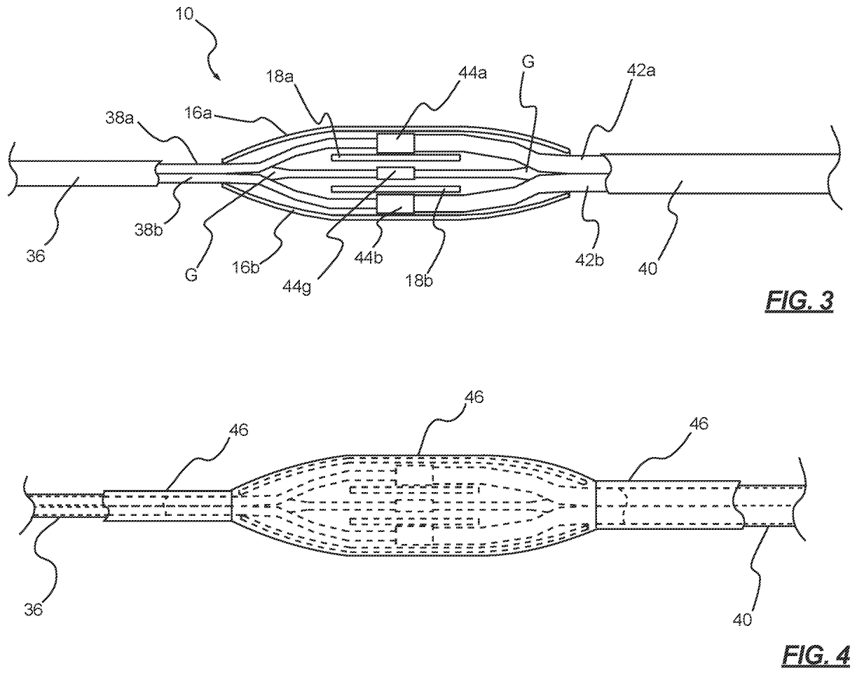

FIGS. 3 and 4 illustrate use of the housing 10 in a cable assembly. In these examples, a hot cable 36 can include at least two hot conductors 38a, 38b. Cold cable 40 can include at least two cold conductors 42a, 42b. As will be appreciated, a connection is required between each of the hot connectors and a corresponding cold conductor to allow current to flow through the heating cable to function properly. In the example shown, cold conductor 42a is coupled to hot conductor 38a at a joint 44a. Cold conductor 42b is coupled to hot conductor 38b at joint 44b. As is also commonly the case, each cable includes a ground G, the two of which can be coupled at joint 44g.

The technology used to create the joints 44a, 44b and 44g can vary: in one aspect, the conductors are soldered to one another to create the joint. As one of ordinary skill in the art will appreciate, this process generally involves stripping a small portion of the insulator from each conductor wire and exposing the bare metal beneath. The ends of the conductor wire once so exposed can be soldered to one another to create an electrically conducting joint. In other embodiments, a crimp sleeve can be used, or some other suitable technology. Whichever technique is utilized, the resulting joint must be electrically insulated from contact with any other conductor, or ground, to avoid a short in the system. In conventional systems, each joint would typically be insulated with a round shrink tube or tubing or the like. Collectively, each of these insulation techniques would result in an overall joint cross section that is much larger in diameter than the conductors themselves.

In the present technology, however, each of the joints 44a, 44b and 44g can be positioned “bare” (or uninsulated) within one of the insulating channels (20, 22a, 22b in FIG. 1). Once so positioned, the joints are electrically insulated from contact with an adjacent joint (and with any external component) by walls 18a, 18b, 16a, 16b. Thus, the joints can be installed within the insulating channels with bare conductor exposed: there is no need to insulate a joint prior to installing it in its respective insulating channel.

Advantageously, the present technology allows each of the joints 44a, 44b and 44g to be installed in a respective insulating channel from above the body 12, through a respective opening 24a, 24c, 24b (FIG. 2A). In this manner, the conductors can be soldered or crimped to one another in a process removed from the housing 10, where the joining can be done in the most effective manner. Once the joints have been prepared, they can be easily lowered into the insulating channels through the openings and insulated laterally from one another by walls 16a, 16b, 18a, 18b.

As shown in FIG. 4, once each of the joints 44a, 44b, 44g is installed within a channel 22a, 22b, 20g, respectively, an insulating wrap 46 can be installed around the entire assembly. The insulating wrap can serve to both retain the joints within their respective channels and also to electrically insulate the joints from contact with any external components. The resulting assembly is electrically sound and presents a sufficiently low profile as to minimize disruption to the flooring installation in which the assembly is installed. The insulating wrap can take a variety of forms, but in one embodiment is a shrink-wrap tube or tubing that is initially larger than the housing such that the entire housing can be fit within the tube. Heat can then be applied to the tube, causing it to shrink and form-fit around the housing and the cables, as is shown in FIG. 4. In other embodiments, the insulating wrap can be a tape-like structure that is wrapped about the housing.

As will be appreciated, the present technology allows the joints to be devoid of insulation beneath the insulating wrap installed about the housing. In this manner, insulating the joints prior to installing them in the housing is unnecessary.

In one aspect of the technology, a diameter of the first 44a and second joints 44b can be equal to or smaller than a height of adjacent walls of the insulation channel within which the first and second joints are positioned. In this manner, the joint is at most flush with the upper walls of the insulation channel, and can be slightly lower than the walls. Similarly, a diameter of the first and second joints can be equal to or smaller than a width between adjacent walls of the insulation channel within which the first and second joints are positioned.

As will be appreciated from FIG. 2A, in one aspect of the invention the inner walls 18a, 18b and outer walls 16a, 16b can each terminate in an upper surface 34a, 34b, 34c, 34d, etc. The insulating wrap 46 (FIG. 4) can be installed in direct contact with these upper surfaces of the inner and outer walls. In this manner, any inadvertent contact of the joints with one another is prevented.

It is noted the figures and description above assume that each cable 36, 40 includes two conductors 38a, 38b, 42a, 42b, respectively, and a ground G. The present technology can readily be adapted, however, to accommodate fewer or more conductors, as the case may be. In these examples, fewer than two or more than two inner walls can be utilized, as the case may be. In addition, each cable may or may not include a ground G: the number of inner walls can be adjusted accordingly in the case where the cable(s) do not include a ground. The ground, where present, can be any of a variety of forms, such as a braid, ribbon, solid wire, stranded wire, etc.

In addition to the structure discussed above, the present technology also presents various methods of manufacturing, assembling, configuring, installing and using heating cable sets. In one example, a method of finishing a cable assembly is provided, including obtaining a cable joint housing described above. The method can include positioning through one of the openings a first joint of a heating cable in one of the insulation channels such that the first joint sits beneath the one of the openings. A second joint of the heating cable can be positioning through another of the openings in another of the insulation channels such that the second joint sits beneath the another of the openings. An insulating wrap can be installed about the housing to thereby provide an insulative barrier above the first and second joints.

Installing the insulating wrap can include installing the insulating wrap in direct contact with upper surfaces of the inner and outer walls. The upper surfaces of the inner and outer walls can lie on substantially the same plane.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the examples.

I claim:

1. A cable joint housing, comprising:
a body integrally formed of an electrically insulating material, the body including:
a floor;
a pair of outer walls, extending upwardly from the floor;
a pair of inner walls, extending upwardly from the floor and positioned intermediate the pair of outer walls, the inner walls forming an inner insulating channel and each of the pair of inner walls forming an outer insulating channel with an adjacent outer wall; and
a pair of openings defined above each of the insulating channels, the openings being devoid of material to allow at least a portion of one or more conductors to be installed into the insulating channels from above, through the openings.

2. The housing of claim 1, wherein a maximum width of the housing is at least three times a maximum height of the housing.

3. The housing of claim 1, wherein the inner walls are spaced and distinct from the outer walls.

4. The housing of claim 1, wherein the inner walls and outer walls each terminate in an upper surface, and wherein the upper surfaces of the inner and outer walls lie on substantially the same plane.

5. The housing of claim 1, wherein the inner walls and outer walls are freestanding under their own weight.

6. The housing of claim 1, wherein the outer walls form a pair of end openings in the housing on opposing ends of the housing, one of the pair of end openings being larger than another of the pair of end openings.

7. A heating cable assembly, comprising:
a cable joint housing, comprising:
a body integrally formed of an electrically insulating material, the body including:
a floor;
a pair of outer walls, extending upwardly from the floor;
a pair of inner walls, extending upwardly from the floor and positioned intermediate the pair of outer walls, the inner walls forming an inner insulating channel and each of the pair of inner walls forming an outer insulating channel with one of the adjacent outer walls; and
a pair of openings defined above each of the insulating channels, the openings being devoid of material to allow at least a portion of one or more conductors to be installed into the insulating channels from above, through the openings;
a hot cable, including at least two hot conductors;
a cold cable, including at least two cold conductors;
one of the hot conductors and one of the cold conductors being connected at a first joint and another of the hot conductors and another of the cold conductors being connected at a second joint;
the first and second joints being positioned in one of the insulation channels beneath one of the openings; and
an insulating wrap, installed about the housing and providing an insulative barrier above the first and second joints.

8. The assembly of claim 7, wherein each of the first and second joints are devoid of insulation beneath the insulating wrap installed about the housing.

9. The assembly of claim 7, wherein a diameter of the first and second joints is equal to or smaller than a height of adjacent walls of the insulation channel within which the first and second joints are positioned.

10. The assembly of claim 7, wherein a diameter of the first and second joints is equal to or smaller than a width between adjacent walls of the insulation channel within which the first and second joints are positioned.

11. The housing of claim 7, wherein the inner walls are spaced and distinct from the outer walls.

12. The housing of claim 7, wherein the inner walls and outer walls each terminate in an upper surface, and wherein the insulating wrap is in direct contact with the upper surface of the inner and outer walls.

13. The housing of claim 12, wherein the upper surfaces of the inner and outer walls lie on substantially the same plane.

14. A method of finishing a cable assembly, comprising:
obtaining a cable joint housing including:
a body integrally formed of an electrically insulating material, the body including:
a floor;
a pair of outer walls, extending upwardly from the floor;
a pair of inner walls, extending upwardly from the floor and positioned intermediate the pair of outer walls, the inner walls forming an inner insulating channel and each of the pair of inner walls forming with one of the adjacent outer walls an outer insulating channel; and
a pair of openings defined above each of the insulating channels, the openings being devoid of material to allow at least a portion of one or more conductors to be installed into the insulating channels from above, through the openings;
positioning through one of the openings a first joint of a heating cable in one of the insulation channels such that the first joint sits beneath the one of the openings;
positioning through another of the openings a second joint of a heating cable in another of the insulation channels such that the second joint sits beneath the another of the openings; and
installing an insulating wrap about the housing to thereby provide an insulative barrier above the first and second joints.

15. The method of claim 14, wherein each of the first and second joints are devoid of insulation beneath the insulating wrap installed about the housing.

16. The method of claim 14, wherein a diameter of the first and second joints is equal to or smaller than a height of adjacent walls of the insulation channel within which the first and second joints are positioned.

17. The method of claim 14, wherein a diameter of the first and second joints is equal to or smaller than a width between adjacent walls of the insulation channel within which the first and second joints are positioned.

18. The method of claim 14, wherein the inner walls are spaced and distinct from the outer walls.

19. The method of claim 14, wherein the inner walls and outer walls each terminate in an upper surface, and wherein installing the insulating wrap includes installing the insulating wrap in direct contact with the upper surface of the inner and outer walls.

20. The method of claim 19, wherein the upper surfaces of the inner and outer walls lie on substantially the same plane.
